(19) United States
(12) Patent Application Publication
(10) Pub. No.: US 2009/0003662 A1
(43) Pub. Date: Jan. 1, 2009

(54) Virtual reality overlay

(75) Inventors: Samuel Joseph, Harrow (GB); Daniel D. Suthers, Honolulu, HI (US); Robert Stephen Brewer, Honolulu, HI (US)

Correspondence Address: CADES SCHUTTE A LIMITED LIABILITY LAW PARTNERSHIP, 1000 BISHOP STREET, 12TH FLOOR, HONOLULU, HI, 96813, US

(73) Assignee: University of Hawaii

(21) Appl. No.: 12/215,811

(22) Filed: Jun. 27, 2008

Related U.S. Application Data
(60) Provisional application No. 60/937,609, filed on Jun. 27, 2007.

(51) Int. Cl. G06K 9/00

(52) U.S. Cl. 382/118

(57) ABSTRACT

A mobile social networking system that provides aspects of an augmented reality experience comprising a wireless infrastructure; at least one central server having a at least one database of users; a mobile scanner that scans for other users through the use of an identification mechanism, queries the server, and downloads the user profiles and displays them on an inconspicuous viewing device. An unobtrusively manipulable input device is used to select and navigate through the profiles. The invention provides a system for obtaining additional social and other information about nearby users in an unobtrusive manner to avoid detection by others.

This application claims priority to U.S. provisional patent application 60/937,609 filed on Jun. 27, 2007, incorporated herein by reference.

### TECHNICAL FIELD

This invention generally relates to Augmented Reality (AR) environments, and more specifically to the development of, and navigation through, an augmented reality environment using an unobtrusively manipulable input device and an inconspicuous viewing device preferably for mobile social networking purposes.

### BACKGROUND ART

As we go about our lives, we pass through spaces filled with people. We interact with some of these people, but we pass by most of them without any interaction. One barrier to interaction is unfamiliarity: we are less likely to talk to a stranger about whom we don't know anything. We also can be forgetful, remembering someone's face, but forgetting their name, organizational affiliation, and interests. There has been a long felt but unsolved need for a socially acceptable solution to this common problem.

The present invention is a system designed to provide additional social information about nearby people in an unobtrusive and inconspicuous manner, and allows users to be more aware of the social environments that they inhabit, through the use of augmented reality technology. The overall goal of the present invention is a system that can be used unobtrusively, allowing users to go about face-to-face social interactions in a normal manner, without detection of the invention's use (by others). Although this invention is being disclosed in connection with social networking, it is applicable to any other areas in which a user needs to unobtrusively receive information about people or objects, such as in law enforcement, and is not limited to social networking applications.

1. Augmented Reality Systems

An augmented reality system is one that combines real and computer-generated information in a real environment, interactively and in real-time, and registers or associates virtual objects with physical ones (Azuma, R. 1997. A survey of augmented reality. Presence: Teleoperators and Virtual Environments, 6(4):355-385, incorporated herein by reference; Azuma, R., Baillot, Y., Behringer, R., Feiner, S., Julier, S., and MacIntyre, B. 2001. Recent advances in augmented reality. IEEE Computer Graphics and Applications, 21(6):34-47, incorporated herein by reference). In other words, augmented reality environments provide relevant information about people or objects in a user's environment through a computer interface. An interface defines the communication boundary between two entities, such as a piece of software, and a hardware device, or between a hardware device and a user. The interface between a human and a computer is called a user interface. The most sophisticated augmented reality systems provide visual data associated with (such as by being overlaid over or pointed to) objects or persons being viewed or perceived by a user. This is known as “image registration”. Augmented reality systems are challenging to implement, largely because of the technical difficulty in achieving image registration. Another challenge is designing input devices that allow the user to interact with the augmented reality environment in an unobtrusive and inconspicuous manner.

2. Location-Based Social Networking Systems.

The possibilities of consumer devices in the mobile social networking field are numerous. Social Network services such as MySpace (http://www.myspace.com/, incorporated herein by reference) and Friendster (http://www.friendster.com/, incorporated herein by reference) already provide an online social network that allows users to create profiles for themselves and specify friendship links (designate those users with whom they have a personal relationship). Commercial systems for mobile and location-based social networking services make use of self-reported location (http://www.socialight.com, incorporated herein by reference), global positioning system (“GPS”) (http://www.loopt.com, incorporated herein by reference), and distance-limited wireless communications protocols such as Bluetooth, in order to provide location and context specific social information. Bluetooth technology is particularly useful when transferring information between two or more devices that are near each other in low-bandwidth situations. It is a wireless protocol that utilizes short-range communications technology to facilitate both voice and data transmissions over short or limited distances from fixed and or mobile devices, creating wireless personal area networks (PANs). Bluetooth was developed to create a single digital wireless protocol, capable of connecting multiple devices and avoiding issues arising from synchronization of devices using different protocols. Bluetooth provides a way to connect and exchange information between personal devices (devices that can be carried by a person or affixed to an object) such as mobile phones, telephones, laptop computers, personal computers, printers, GPS receivers, digital cameras, and video game consoles, over a secure, globally unlicensed ISM (Industrial, Scientific, and Medical) 2.4 GHz (gigahertz) short-range radio frequency bandwidth.

Every Bluetooth device is also capable of “device-discovery” (or “Bluetooth sensing”), which allows the device to collect information on other Bluetooth devices within 5-10 meters (Costanza E., Inverso S. A., Pavlov E., Allen R., Maes P., (2006) eye-q: Eyeglass Peripheral Display for Subtle Intimate Notifications. Proc. of MobileHCI 2006, September 2006, Espoo, Finland, incorporated herein by reference). The information collected includes a unique Bluetooth Media Access Control (MAC) address (Bluetooth Identifier or BTID), a device name, and the type of device. The Bluetooth MAC address is a 3-bit address used to distinguish between Bluetooth enabled devices. The BlueAware system (Eagle N. & Pentland. A. S. (2006) Reality mining: sensing complex social systems. Personal Ubiquitous Computing. 10(4):255-268, incorporated herein by reference) runs in the background on Mobile Information Device Profile (MIDP)2-enabled phones allowing them to record and timestamp BTIDs in a proximity log and makes then available to other applications. Researchers have been using the BTID patterns to analyze and predict relationships between users and organizational rhythms (Eagle N. & Pentland. A. S. (2006) Reality mining: sensing complex social systems. Personal Ubiquitous Computing. 10(4):255-268, incorporated herein by reference; Perkio J., Tuulos V., Hermersdorf M., Nyholm H., Salminen J. & Tirri H (2006) Utilizing Rich Bluetooth Environments or Identity Prediction and Exploring Social Networks as Techniques for Ubiquitous Computing. IEEE/WIC/ACM International Conference on Web Intelligence. 137-144, incorporated herein by reference). Commercial social networking systems such as MobiLuck (http://www.mobiluck.co.uk, incorporated herein by reference) allow cellular phones to detect nearby Bluetooth devices (ringing or vibrating when found), and the system supports message and photo exchange. WirelessRope is a system that uses Bluetooth sensing to support contact between groups of colleagues at a conference (Nicolai T., Yoneki E., Behrens N. & Kenn H. (2006) Exploring Social Context with the Wireless Rope. 1st International Workshop on MObile and NEtworking Technologies for social applications, incorporated herein by reference). The Jabberwocky system (Paulos, E. and Goodman, E. 2004. The familiar stranger: anxiety, comfort, and play in public places. In Proceedings of the SIGCHI Conference on Human Factors in Computing Systems (Vienna, Austria, Apr. 24-29, 2004). CHI '04. ACM, New York, N.Y., 223-230, incorporated herein by reference) investigates the “familiar stranger concept” of people who have seen each other in public places on multiple occasions but have never met. The Jabberwocky devices log BTIDs but do not use a central server.

These systems give an idea of the possibilities of consumer devices in the mobile social networking field. In addition, there have been many custom social networking applications developed in the wearable computing field including Lovegety (Iwatani, Y. Love: Japanese Style. Wired News, 11 Jun. 1998, incorporated herein by reference), GroupWear (Borovoy, R., Martin, F., Resnick, M., and Silverman, B. (1998) GroupWear: nametags that tell about relationships. Late-Breaking Results CHI 98, 329-330, incorporated herein by reference), Smart-Its Friends (Holmquist L. E., Mattern F., Schiele B., Alahuhta P., Beigl M. & Gellersen H.-W. Smart-Its Friends: A Technique for Users to Easily Establish Connections between Smart Artefacts. Proc. Ubicomp, (2001), 116-122, incorporated herein by reference), nTag (http://www.ntag.com/, incorporated herein by reference), CharmBadge (http://www.charmed.com/products/charmbadge.html, incorporated herein by reference), SpotMe (http://www.spotme.com/, incorporated herein by reference), Ubi-finger (Tsukada, K. and Yasumura, M. (2002) Ubi-Finger: Gesture Input Device for Mobile Use. Proceedings of APCHI 2002, 388-400, incorporated herein by reference), GestureWrist (Rekimoto, J. (2001) GestureWrist and GesturePad: Unobtrusive Wearable Interaction Devices, Proceedings of 5th International Symposium on Wearable Computers, incorporated herein by reference), GesturePendant (Starner, T., Auxier, J., Ashbrook, D. & Gandy, M. (2000) The Gesture Pendant: A Self-illuminating, Wearable, Infrared Computer Vision System for Home Automation Control and Medical Monitoring, Proceedings of 4th International Symposium on Wearable Computers, incorporated herein by reference), FieldMouse (Masui, T. and Siio, I. (2000) Real-World Graphical User Interfaces, Proceedings of The International Symposium on Handheld and Ubiquitous Computing, 72-84, incorporated herein by reference), AirReal (Hoshino T., Horii Y., Maruyama Y., Katayama A., Shibata Y & Yoshimaru T. (2001) AirReal: Object-Oriented User Interface for Home Network System,” Workshop on Interactive Systems and Software, 113-118. (In Japanese), incorporated herein by reference), Twiddler (http://www.handykey.com/), incorporated herein by reference, FingeRing (Fukumoto, M. & Tonomura, Y. (1997) Body coupled FingeRing: Wireless wearable keyboard, Proceedings of the ACM Conference on Human Factors in Computing Systems, Addison-Wesley, 147-154, incorporated herein by reference), DataGlove (http://www.5dt.com/, incorporated herein by reference), and WearTrack (Foxlin, E. & Harrington, M. (2000) WearTrack: A Self-Referenced Head and Hand Tracker for Wearable Computers and Portable VR. In 4th Int'l Symposium on Wearable Computers: 155-162, incorporated herein by reference). Another interesting system that incorporates gestural language is iBand (Kanis M., Winters N., Agamanolis S., Gavin A., & Cullinan C.(2005) Toward Wearable Social Networking with iBand, CHI 2005 Extended Abstracts on Human Factors in Computing Systems, Portland, Oreg., 2-7 ACM Press, incorporated herein by reference) which is a social networking device that creates connections between two users when they shake hands.

Rather than having a social information exchange take place by conscious, directed, user to user, communication, the present invention is an alternative system designed to provide additional social and other information about nearby users or objects in an unobtrusive manner for social networking or other purposes. It preferably utilizes a high-speed wireless infrastructure, and at least one central server that contains at least one database where profiles of users can be stored. An identification mechanism identifies a user and links or associates the identified user with his or her profile(s), and preferably uses at least one of the following: device detection or face recognition (discussed more fully below), although any other identification now known or hereafter invented can be used. In device detection, a user's personal device (such as a mobile phone) can be registered and associated with a unique profile (or multiple profiles) in the database. A mobile scanning device preferably scans for nearby (proximate) personal devices. When the mobile scanning device detects another personal device, it preferably queries the central server to find out if there is a unique profile associated with the personal device. If so, it downloads the unique profile (depending on which parts of the profile a user has decided to make publicly available). The unique profile is then preferably displayed to the user as an icon (thumbnail image, virtual object, or other symbol, including a name or word) on an inconspicuous viewing device. Other nearby users with personal devices are also represented as icons in the viewing device. An unobtrusively manipulable input device, such as a ring or pen fitted with a small number of buttons, is preferably used to unobtrusively (subtly) navigate through and select icons. Ultimately, it is the user who controls the systems by using the buttons on the input device to scroll, select, and view profile information associated with the personal devices carried by nearby users.

Examples of unobtrusively manipulable input devices include: Ring Mouse (LaViola, J., Acevedo, D., Keefe, D., and Zeleznik, R. (2001) Hands-Free Multi-Scale Navigation in Virtual Environments. Proceedings of ACM Symposium on Interactive 3D Graphics, Research Triangle Park, North Carolina, 9-15, incorporated herein by reference) which has two buttons and ultrasonic tracking for position information. However, two buttons alone are insufficient for navigation purposes. FingerSleeve (LaViola, J. J. Jr., Keefe, D. F., Zeleznik, R. C., and Feliz, D. A. (2004) Case Studies in Building Custom Input Devices for Virtual Environment Interaction. IEEE VR Workshop, 2004, incorporated herein by reference; Zeleznik, R. C., LaViola, J. J. Jr., Feliz, D. A., and Keefe, D. F. (2002) Pop Through Button Devices for VE Navigation and Interaction. Proceedings of the IEEE Virtual Reality, 2002, incorporated herein by reference) is a little bigger than Ring Mouse but more complete in terms of functionality. Besides buttons, it has a tracker, which has the ability to sense all movement, translation, and orientation changes. This enables the user to navigate smoothly and efficiently. However, it is still rather large. On the consumer market, companies are also coming up with new ideas. Global Link has a ring-type mouse, which is actually just a tiny trackball mouse (http://www.engadget.com/2007/06/10/the-ring-mouse-from-global-link-for-convenient-cursoring/, incorporated herein by reference).

The inconspicuous viewing device is essentially a head-up display (“HUD”) that allows the user to display profile icons (or other virtual objects) and information. A HUD is any transparent display that presents data without obstructing the user's view. Although HUDs were initially developed for military aviation, HUDs are also used in commercial aircraft, automobiles, and other applications. Examples of inconspicuous viewing devices include: Micro Optical's SV-6 and DV-3 viewers which are essentially a pair of glasses. However, commercial production of those devices has ceased. New technologies such as retinal scanning are creating higher quality displays that might be used for future HUD systems. Microvision's Nomad display system ND 2000 uses a low power laser to project an image onto the retina, but this requires a head set that is rather bulky. It is also no longer being manufactured. LitEye sells HUD like the LE-750 (http://www.liteye.com/, incorporated herein by reference), but it is bulky and not well suited for unobtrusive social networking purposes.

The present invention provides the combination of an unobtrusively manipulable input device, inconspicuous viewing device, and other unobtrusive components, for minimizing detection of its use, for social networking and other purposes. For example, the invention allows a user to chat with someone, while simultaneously obtaining social information on that person without drawing attention to the fact that the user is utilizing the system. The following patents and patent applications may be considered relevant to the field of the invention:

U.S. Pat. No. 7,188,153 to Lunt, et al., incorporated herein by reference, discloses an online social network that collects descriptive data about various individuals and allows those individuals to indicate other individuals with whom they have a personal relationship. The descriptive data and the relationship data are integrated and processed to reveal the series of social relationships connecting any two individuals within a social network.

U.S. Pat. No. 7,117,254 to Lunt, et al., incorporated herein by reference, discloses a method of inducing content uploads in an online network, including the steps of storing content relating to a first member of the network that is submitted by a second member of the network, receiving approval of the content from the first member, and associating the content with the first member. The uploaded content may comprise an image file containing a photo of the first member and a caption associated with the photo image.

U.S. Pat. No. 7,069,308 to Abrams, incorporated herein by reference, discloses a method and apparatus for calculating, displaying and acting upon relationships in a social network.

### DISCLOSURE OF INVENTION

The present invention described herein and more fully below, is an augmented reality system used to acquire additional social and other information without detection by others. It preferably comprises the elements of a wireless communications infrastructure and at least one central server containing at least one database of users where each user of the system can store a unique profile or profiles. An identification mechanism identifies nearby users and a mobile scanner downloads the unique profile or profiles associated with each of the nearby users, from the central server. An inconspicuous viewing device displays the unique profile or profiles associated with the nearby users as icons. The user can then select an icon using an unobtrusively manipulable input device, and view the unique profile information associated with the nearby users, without detection by others.

Another preferred embodiment of the invention can integrate multiple live feeds from other sources containing social information.

Another preferred embodiment of the invention uses device detection as the identification mechanism where users can register a personal device on the database and store a unique profile associated with their registered personal device.

Another preferred embodiment of the invention uses face recognition as the identification mechanism that associates a user with his or her unique profile.

Another preferred embodiment of the invention allows for peer to peer networking in which profiles are downloaded and obtained directly from other nearby personal devices without the need for a central server.

The present invention described herein and more fully below, also comprises scanning for a proximate distance-limited wireless communications protocol personal device using a user distance-limited wireless communications protocol personal device, and triggering the display of profiles of people or objects.

The system and process described in the present invention enable a user to acquire additional social and other information about his or her environment, including persons with whom they are interacting, while avoiding detection of the system's use by others.

### BRIEF DESCRIPTION OF DRAWINGS

FIG. 1 shows a flow diagram that depicts a basic overview of the present invention using device detection as the identification mechanism.

FIG. 2 depicts one embodiment of the user interface of the inconspicuous viewing device from a user's perspective, showing social information overlaid onto the user's field of view FIG. 3 depicts one embodiment of the user interface of the inconspicuous viewing device from a user's perspective, showing social information about other persons overlaid onto the user's field of view with full image registration (augmented reality).

FIG. 4 depicts the embodiment of FIG. 2 or FIG. 3 where an input device has been used to select a particular user profile, and the display of additional social information available from that profile.

### BEST MODES FOR CARRYING OUT INVENTION

1. The Basics

It is presently preferred that the invention described herein starts with a wireless communications infrastructure, preferably a high-speed wireless communications infrastructure, and at least one central server containing at least one database. Preferably, users can store a unique profile or profiles in this database.

Another preferred embodiment of the invention uses peer to peer networking without the use of a central server or database, so that profile information is downloaded and obtained directly from other users' personal devices.

Presently, the central server is preferably implemented in Ruby on Rails (http://www.rubyonrails.org/, incorporated herein by reference) as part of the larger disCourse system (a LILT developed online collaboration system) (http://lilt.ics.hawaii.edu/lilt/software/disCourse/index.html, incorporated herein by reference; http://lilt.ics.hawaii.edu/lilt/index.html, incorporated herein by reference). DisCourse already has a profile system where each user can enter data about himself or herself. The present invention adds the ability to store unique profiles (BTIDs with an associated profile).

2. Identification Mechanism

It is presently preferred that the invention uses an identification mechanism to identify nearby users. The identification mechanism links or associates a specific user with his or her profile(s), and preferably uses at least one of the following: device detection or face recognition, but any other identification mechanism now known or hereafter invented can be used.

Another preferred variation of the present invention allows the user to select a range or direction, so that the identification mechanism is triggered only by persons or objects within that range or direction.

a. Device Detection

Each of the users must register a personal device (such as a mobile phone, music player, laptop computer, GPS receiver, digital camera, etc.) with the database, and create a unique profile associated with each device. Personal devices are those that can be carried by a person or affixed to an object. Each personal device preferably has distance-limited wireless communications protocol ability, and therefore has a limited-distance (short range) of interactivity with other personal devices.

The presently preferred embodiment of the invention uses Bluetooth devices (which have a wireless protocol that utilize short-range communications technology and are capable of device discovery). It also preferably contains a scanner (described more fully below), preferably a mobile scanner, which scans for other nearby (proximate) personal devices by searching for broadcasts of BTIDs from other users' Bluetooth devices. For each personal device detected, the mobile scanner queries (contacts) the central server via a high-speed wireless communications link to check for a profile associated with the BTID of the detected personal device. If a profile is found, the contents of the profile are preferably downloaded to the mobile scanning device, and displayed as an icon (thumbnail image, virtual object, or other symbol, including a name or word) on an inconspicuous viewing device (described below), although, alternatively, downloading can be done on demand. The BTID and profile are preferably downloaded automatically. An extended profile can be downloaded at the option of the user. All the available icons are added to a list of nearby devices. The user can navigate among the list of detected personal devices using the unobtrusively manipulable input device, and can choose to display (or download) profiles or extended profiles associated with a particular personal device. Personal devices that are not associated with a profile preferably are also displayed, but the only information displayed is the name that the device provides (such as “Sam Joseph's iPhone”).

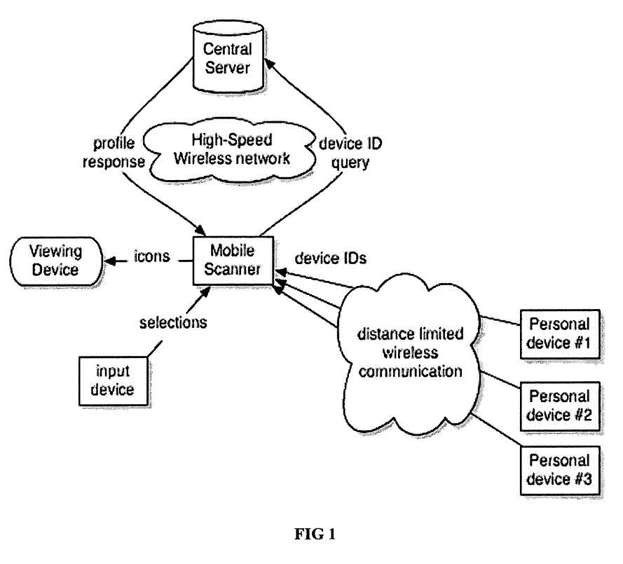

FIG. 1 is a flow diagram showing the basic overview of the present invention using device detection as the identification mechanism.

b. Face Recognition

Another preferred variation of the present invention uses face recognition as the identification mechanism, wherein identification is accomplished using a mobile scanner to recognize other users' faces, and then to match their faces against a database. Subsequently, the profiles of those identified persons are downloaded and selected in the manner described above.

3. The Mobile Scanner

As stated above, It is presently preferred that the mobile scanner is a computer that scans for nearby (proximate) distance-limited wireless communications protocol personal devices by detecting, for example, the broadcasts of BTIDs from other Bluetooth devices. Once detected, the scanner preferably queries a central server to see if there is a unique profile associated with the personal device, downloads the profile information associated with the personal device, and creates an icon (thumbnail image, virtual object, or other symbol, including a name or word) representing the nearby personal devices on the inconspicuous viewing device (discussed more fully below). This is preferably done in such a way that there is image registration with the icon. Subsequently, using the unobtrusively manipulable input device (discussed below), the user can select an icon or other symbol and request information associated with that icon or other symbol. The mobile scanner then fulfills the user's request, and then displays (or downloads) the requested information in the inconspicuous viewing device, e.g. more information on the favorite shops of a particular individual, or what pets he or she owns.

The mobile scanner preferably queries the server and downloads profiles via a Hypertext Transfer Protocol (HTTP) query over the Internet using a wireless infrastructure that is preferably high-speed. HTTP is a communications protocol for the transfer of information on the internet and the World Wide Web. It is a standard request/response between a user and a server. The user preferably makes a HTTP query to the central server containing the most recently detected BTID. If there is a profile associated with the BTID of the personal device, the server preferably replies with an XML (Extensible Markup Language) document containing the profile contents. XML is a general purpose specification for creating custom artificial languages. It is classified as an extensible language because it allows its users to define their own elements. Its primary purpose is to facilitate the sharing of structured data across different information systems, particularly via the Internet, and it is used both to encode documents and to serialize data.

Presently the invention uses a Samsung Q1 UMPC (Ultra Mobile PC or UMPC) for the mobile scanner. UMPCs are like oversized PDAs (personal digital assistants), but they run full versions of Windows like laptop computers (http://www.samsung.com/us/consumer/type/type.do?group=computersperipherals&type=ultramobilepc, incorporated herein by reference). The Samsung model has built in Bluetooth, WiFi, USB ports (Universal Serial Bus ports), and a VGA port (Video Graphics Array port) for connecting to the HUD (the viewing device, discussed more fully below). WiFi is a type of wireless network that can be configured to set up shared resources, transmit files, and to set up audio links. It uses the same radio frequencies as Bluetooth, but with higher power resulting in a stronger connection. USB ports were designed to allow many different hardware devices to connect to each other using a single standardized interface socket.

In terms of unobtrusiveness, the Samsung UMPC, while small for a Windows XP computer, is still quite large for a wearable device. The UMPC includes many features that are useful. However, features such as the LCD touch input screen, define the overall size of the device. Instead of the Samsung UMPC, the present invention could alternatively use a small, embedded system such as the Gumstix platform (http://www.gumstix.com/index.html), incorporated herein by reference.

a. Software

It is presently preferred that the software running on the mobile scanner be written in language that allows for cross-platform development and deployment, such as Java. The invention's software presently runs on Mac OS X, while the invention's hardware presently runs on Windows XP. Particularly noteworthy is the availability of a cross-platform specification for using Bluetooth with Java, known as JSR 82 (http://jcp.org/en/jsr/detail?id=82, incorporated herein by reference). The Aventana JSR82 implementation (http://www.avetana-gmbh.de/avetana-gmbh/produkte/jsr82.eng.xml, incorporated herein by reference) works on Mac OS X, Windows, and Linux, but it is tied to a particular Bluetooth adapter BTID. The BlueCove project (http://code.google.com/p/bluecove/, incorporated herein by reference) is working on a JSR82 implementation for Windows, Mac OS X, and Linux. The present invention preferably uses both Avetana on Mac OS X and Blue Cove.

4. The Unobtrusively Manipulable Input Device

It is presently preferred that the invention utilizes an unobtrusively manipulable input device that is small and substantially indistinguishable from an article of jewelry or other inconspicuous personal object, for example, a pen or a ring, that someone might manipulate without drawing attention to himself or herself. The navigation interface on the input device is preferably designed to be simply navigated using a very small number of commands, (for example, left, right and enter) and a small number of buttons (preferably at least three), so the device can be manipulated unobtrusively.

A preferred variation of the input device contains motion detectors. Motion detectors allow the user to draw or write by detecting the motion of the user's hand; allow the user to add free hand notes to the augmented reality environment; and allow the user to move the free hand notes around, for example, by simultaneously holding the select button down and moving his or her hand around.

It is presently preferred that the invention uses either the Kensington Wireless Presenter or MagicRing (or MagicPen device) (as described in U.S. provisional patent application 60/937,609, incorporated herein by reference) for an input device. The Kensington Wireless Presenter (http://us.kensington.com/html/11190.html, incorporated herein by reference) is a simple remote control that has four buttons laid out in four cardinal directions. The USB adapter is connected to a computer and identifies the remote as a USB keyboard, which most operating systems (computer software) should recognize without special drivers. The various buttons on the remote control send keyboard commands useful when giving a presentation in PowerPoint (for example, page up, page down, F5, and escape). This is an inexpensive option for the input device.

The MagicRing or MagicPen is preferably a pen or ring that contains at least three buttons. One button is preferably used to jump from one icon (thumbnail image, virtual object, or other symbol, including a name or word) to another, and a second button is preferably used to select an icon. Preferably, a “jump back” icon, is also provided, so that these two buttons can be used to navigate all the icons in the augmented reality environment. Selecting a particular icon preferably changes the mode of the jump button so that it will cycle through a set of icons in association with the selected icon, in addition to retaining the default “jump back” function which allows the user to jump back to the previous level. The third button preferably toggles the augmented reality components off or on. Preferably, the MagicRing or MagicPen is wireless.

5. The Inconspicuous Viewing Device

It is presently preferred that the inconspicuous viewing device uses a transparent HUD which allows the user to display an icon (thumbnail image, virtual object, or other symbol, including a name or word) without obstructing the user's field of view on the user interface (described below). Preferably, the HUD is also inconspicuous to minimize obtrusiveness, for example, built into an existing pair of glasses.

Presently the invention uses a HUD sold by Creative Displays Systems called the i-Port (http://www.creativedis.com/, incorporated herein by reference). The i-Port consists of a modified pair of Oakley brand sunglasses with the display mounted onto the right-hand side. The display is housed in a ball and socket joint that allows the user to orient it for optimal viewing results. While the i-Port is not a completely transparent HUD, it does not occupy the user's full field of view and allows for situational awareness on the right side. The invention will preferably use a display from Lumus Ltd. (http://www.lumus-optical.com/, incorporated herein by reference), which may provide a sleeker see-through HUD. Moreover, new technologies such as retinal scanning are creating higher quality displays that can be used for future HUD systems.

a. The User Interface

As stated above, the mobile scanner displays the list of nearby people to a user via the inconspicuous viewing device. Buttons pressed on the unobtrusive input device signal the mobile scanner to cycle through the list of nearby people, and display additional information from selected profiles on the user interface of the inconspicuous viewing device.

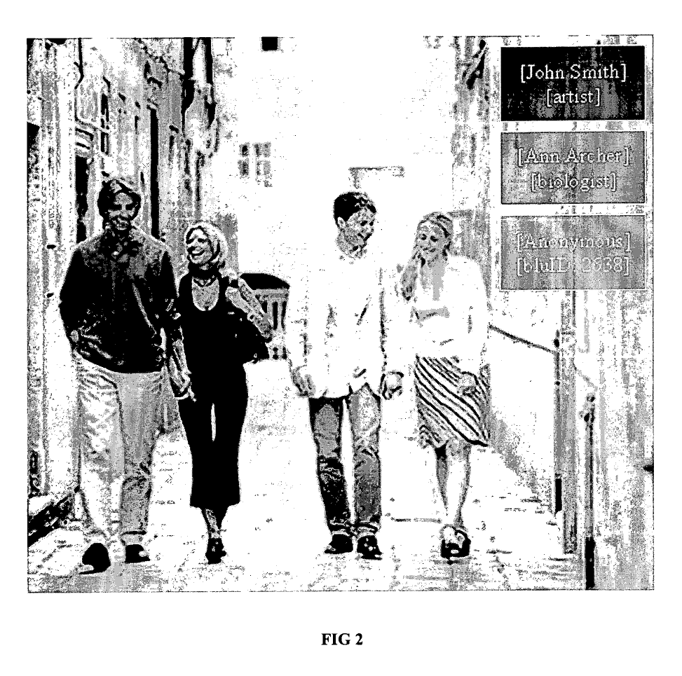

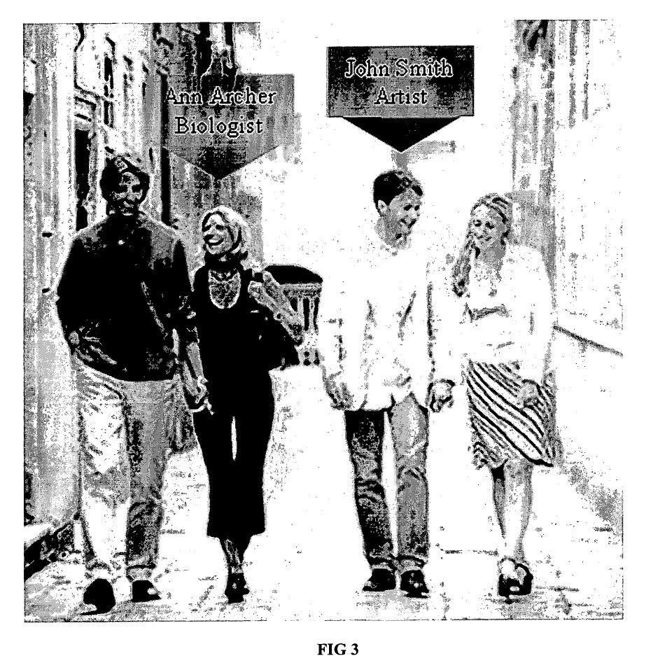

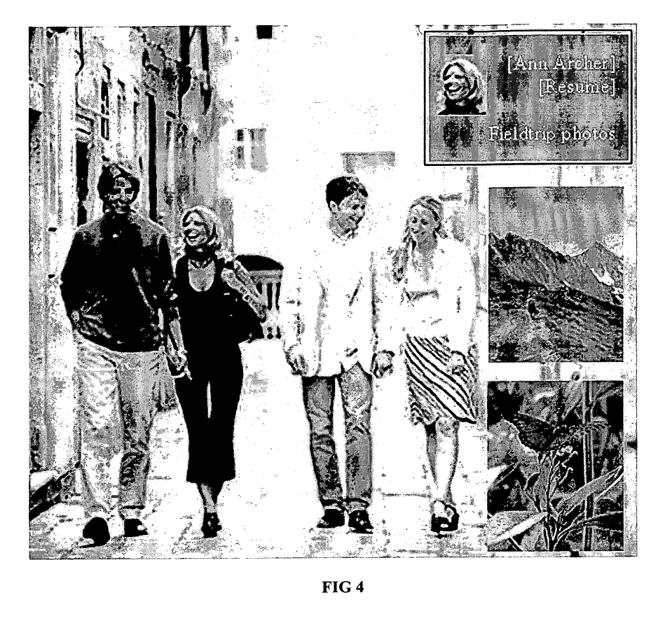

FIG. 2 and FIG. 3 each depict an embodiment of the user interface of the inconspicuous viewing device from a user's perspective. FIG. 2 shows social information overlaid onto a user's field of view. FIG. 3 shows social information overlaid onto a user's field of view with full image registration (augmented reality). FIG. 4 shows when an input device has been used to select a particular user profile, and the display of additional social or other information from that profile.

The user interface preferably presents the information in the peripheral vision of the users similar to the eye-q system (Costanza E., Inverso S. A., Pavlov E., Allen R., Maes P., (2006) eye-q: Eyeglass Peripheral Display for Subtle Intimate Notifications. Proc. of MobileHCI 2006, September 2006, Espoo, Finland, incorporated herein by reference). It displays the detected users as an icon, and the currently selected profile. Log messages are displayed at the bottom of the window showing the status of Bluetooth scans and any errors encountered.

Presently the invention preferably uses an interface that utilizes white text on a black background because on some optical see-through HUDs black is transparent, thus avoiding unnecessary occlusion (obstruction) and allowing the user to see through the interface better. To navigate the interface, the user selects an icon from a list of nearby devices which are displayed on the viewing device. Selection is accomplished by using buttons on the unobtrusive manipulable input device to scroll up and down the screen. Moving the selection off the top or bottom of the list causes the profile area to be cleared, allowing the user to see his or her physical environment instead of the interface. When another person is selected with the input device, that person's unique profile is displayed, showing his or her name, picture, and phone number, and any other information he or she wishes to be public. The user can then toggle (jump) between an extended profile (such as a personal biography) and an abbreviated profile, using the input device.

6. Beyond Profiles

It is presently preferred that the invention integrates multiple live feeds from other sources that contain social information (e.g. multiple social networking systems, multiple databases, blog posts, and e-mail servers), and allows users to merge the data into an appropriate display to the user.

For example, preferably the invention supports profile retrieval from other social networking sites such as FaceBook (http://www.facebook.com, incorporated herein by reference). FaceBook provides an API (application programming interface) for developers (http://developers.facebook.com/resources.php, incorporated herein by reference) that allows fetching of profile information, and even provides a Java client library that should facilitate integration with the present invention. API is a source code interface that an operating system, library, or service provides to support requests made by computer programs.

It is presently preferred that the invention can also display data from other sources such as blog posts, and can display e-mail messages from the detected person. This is particularly useful for users who are not always caught up on reading their e-mail, and prevents the detected person from having to repeat himself or herself in person.

7. Privacy

It is presently preferred that this invention includes privacy management techniques to provide users with options beyond full public profile access. With any social networking application, privacy issues are crucial and this is especially true in a mobile wireless environment.

For example, the SmokeScreen system (Cox, L. P., Dalton, A., and Marupadi, V. 2007. SmokeScreen: flexible privacy controls for presence-sharing. In Proceedings of the 5th international Conference on Mobile Systems, Applications and Services [San Juan, Puerto Rico, Jun. 11-13, 2007]. MobiSys '07. ACM, New York, N.Y., 233-245, incorporated by reference) provides a method for presence sharing between strangers using a centralized broker service. It allows users to engage in presence sharing using BTIDs or WiFi MAC addresses, but provides privacy management through cryptography. Users within a group of friends can broadcast opaque identifiers using the Bluetooth device name field that can only be decrypted by other members of their group of friends.

While the present invention has been particularly shown and described with reference to embodiments described in the detailed description and illustrated in the figures, it will be understood by those skilled in the art that various changes in detail may be effected therein without departing from the spirit and scope of the invention, as defined by the claims. Accordingly, no limitations are to be implied or inferred except as explicitly set forth in the claims.

### INDUSTRIAL APPLICABILITY

This invention allows users to acquire additional social or other information about other nearby users in their environment without detection, for social networking purposes. It may have other applications such as in any other area in which a user needs to be able to unobtrusively receive information about people or an object, such as in law enforcement.

What is claimed is:

1. An augmented reality system comprising:
a wireless communications infrastructure;
central server containing a database of users wherein each of said users can store a unique profile;
a mobile scanner that utilizes an identification mechanism to identify nearby users, and downloads said unique profile associated with each of said nearby users from said central server through said wireless communications infrastructure;
an inconspicuous viewing device that displays icons associated with said nearby users as they are being viewed;
a unobtrusively manipulable input device used to navigate and select among said icons to view information relating to said unique profile associated with a selected nearby user on said inconspicuous viewing device; and
wherein said system is used to acquire additional information about said selected nearby user without detection by others.

2. A system according to claim 1 wherein said identification mechanism comprises device detection.

3. A system according to claim 1 wherein said identification mechanism comprises face recognition detection.

4. An augmented reality system comprising:
a wireless communications infrastructure;
a plurality of central servers containing a plurality of databases of users wherein each of said users can store a plurality of unique profiles;
a plurality of other sources that contain social information;
a mobile scanner that utilizes an identification mechanism to identify nearby users, and downloads said plurality of unique profiles and said social information associated with said nearby users from said plurality of central servers and said plurality of other sources, through said wireless communications infrastructure;
an inconspicuous viewing device that displays icons associated with said nearby users as they are being viewed;
a unobtrusively manipulable input device used to navigate and select among said icons to view information relating to said plurality of unique profiles and said social information about a selected nearby user on said inconspicuous viewing device; and
wherein said system is used to acquire additional information about said selected nearby user without detection by others.

5. A system according to claim 2 wherein said identification mechanism comprises device detection.

6. A system according to claim 2 wherein said identification mechanism comprises face recognition detection.

7. An augmented reality system comprising:
a wireless communications infrastructure;
a mobile scanner that scans for nearby personal devices, queries said nearby personal devices, and downloads a unique profile from each of said nearby personal devices through said high-speed wireless infrastructure;
an inconspicuous viewing device that displays each of said unique profiles as an icon;
a unobtrusively manipulable input device used to navigate and select among said icons to view information relating to said unique profile on said inconspicuous viewing device; and
wherein said system is used to acquire information associated with said personal devices without detection by others.

8. A process comprising the steps of:
scanning for IDs of a proximate distance-limited wireless communication protocol personal device using a user distance-limited wireless communication protocol personal device; and
triggering the display of profiles of people or objects.
